(19) United States
(12) Patent Application Publication
(10) Pub. No.: US 2009/0126578 A1
(43) Pub. Date: May 21, 2009

(54) Device and Disposable Capsule For Producing Liquid Products, in Particular Beverages

(76) Inventors: Beatrice Amann, Kilchberg (CH); Maurizio Alaimo, Neuendorf (CH)

Correspondence Address: BRIAN ROFFE, ESQ, 11 SUNRISE PLAZA, SUITE 303, VALLEY STREAM, NY, 11580-6111, US

(21) Appl. No.: 11/910,555

(22) PCT Filed: Mar. 25, 2006
(86) PCT No.: PCT/EP2006/002768

§ 371 Date: Nov. 6, 2007

(30) Foreign Application Priority Data
Apr. 4, 2005 (EP) 05405281.6

(51) Int. Cl. A47J 31/24; A47J 31/06

(52) U.S. Cl. 99/295; 99/302 R

(57) ABSTRACT

The invention relates to a device for producing liquid products, in particular drinks. According to the invention, an infusion module (3) is used to extract or dissolve a powder or granulate which are contained in a disposable capsule (1) in a pressurised liquid. Said disposable capsule (1) has a dimensionally stable housing (11) which forms a cavity (10) for the powder or granulate and has a front wall on the inlet side and a front wall on the outlet side (12, 13). The inlet-sided front wall (12) comprises a inlet closure which is actively connected to the infusion module (3) and the outlet-sided front wall (13) comprises an outlet closure (19) for the finished product. The inlet closure and the outlet closure (16, 19) are open due to a hydraulic effect of the liquid which is guided from the infusion module (3) under a defined pressure. As a result, no additional elements are required for piercing the disposable capsule which enables the inventive device to be constructed in a simple manner.

The invention concerns a device for producing liquid products, in particular beverages, by means of extraction or dissolving a powder or granulate in a disposable capsule by supplying a liquid under pressure according to the preamble of claim 1, and a disposable capsule according to the preamble of claim 6.

A means of this type is for example known from U.S. Pat. No. 6,026,732. It comprises a capsule holder, into which a cup-shaped disposable capsule closed with a lid is positioned on an extraction plate with the lid facing downwards, and which can be joined together with an infusion module, whereby the disposable capsule is perforated at the top for adding liquid, and the lid is also perforated by the extraction plate. The capsule holder comprises a conically tapered floor with a central outlet channel. The prepared beverage exiting through the perforated lid flows across the bottom and through the outlet channel of the capsule holder into a container positioned underneath. With this means the beverage comes into direct contact with the part of the infusion module supplying the liquid, and in particular also with the bottom and the outlet channel of the capsule holder.

In this way a flavour and a hygiene problem can be created if different products, e.g. beverages are produced with the same means, as a small residual amount of liquid from the previously prepared beverage always reaches the subsequent product and an undesired aftertaste can therefore result.

It is the purpose of this invention to provide a device of the type mentioned above as well as a disposable capsule for such a device, with which it is possible to produce different liquid products without restriction with regard to the flavour or the hygiene of the same.

This task is solved in accordance with the invention by a device with the characteristics of claim 1 as well as a disposable capsule with the characteristics of claim 6.

Further preferred embodiments of the device of the invention as well as the disposable capsule of the invention form the subject of the dependent claims.

The disposable capsule comprises a hollow space for the form-stable housing enclosing the powder or granulate with an inlet side and an outlet side facing wall. The outlet channel for the finished product is not located in the capsule holder, but is associated with the outlet side facing wall of the disposable capsule and equipped with an outlet closure. The inlet side facing wall is equipped with an inlet channel, which is in turn equipped with an inlet closure. The inlet as well as the outlet closure are opened by means of hydraulic force applied by the liquid supplied by the infusion module under a pre-determined pressure, whereby no part of the infusion module comes into contact with the product, e.g. the beverage, and the same also does not contact the capsule holder, so that any risk of flavour or hygiene deterioration during the production of different products with the same means is eliminated. This is important in particular for the construction of fully automatic devices where different beverages are to be dispensed at the push of a button.

Both closures are torn open by means of the liquid pressure alone, e.g. no additional means for perforating the disposable capsule are necessary. This enables a simple construction of the means of the invention.

The disposable capsule according to the invention can as before be inserted into a capsule holder and held in the infusion module together with the same, or it can be inserted manually directly into a capsule holder module integrated into the device or via an insertion tray, or inserted fully automatically, whereby the infusion module is adjusted to suit the inlet channel of the disposable capsule inserted into the capsule holder.

The disposable capsule is designed in such a way that the inlet side facing wall widens conically from the inlet channel in a downward direction and encloses an inlet chamber which is separated from the hollow space for the powder or granulate by a filter. The liquid entering through the inlet channel is distributed across the entire capsule surface within the inlet chamber, so that maximum use is made of the capsule contents. The outlet side facing wall is also preferably conically tapered, whereby the same narrows in a downward direction towards the outlet channel and encloses an outlet chamber that is separated from the hollow space for the powder or granulate by means of a sieve, in which the finished product is collected before being dispensed through the opened outlet channel.

The invention will now be described in more detail with reference to the drawings. These show the following schematic illustrations:

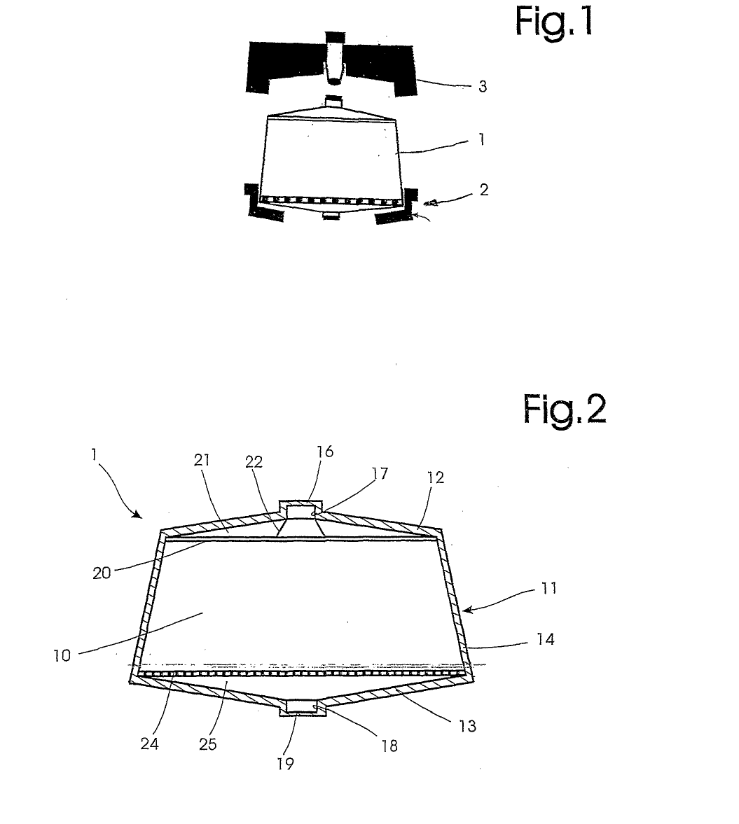

FIG. 1 shows a means of the invention for producing liquid products, with a disposable capsule inserted into a capsule holder and an infusion module;

FIG. 2 shows a vertical cross-section of the disposable capsule illustrated in FIG. 1;

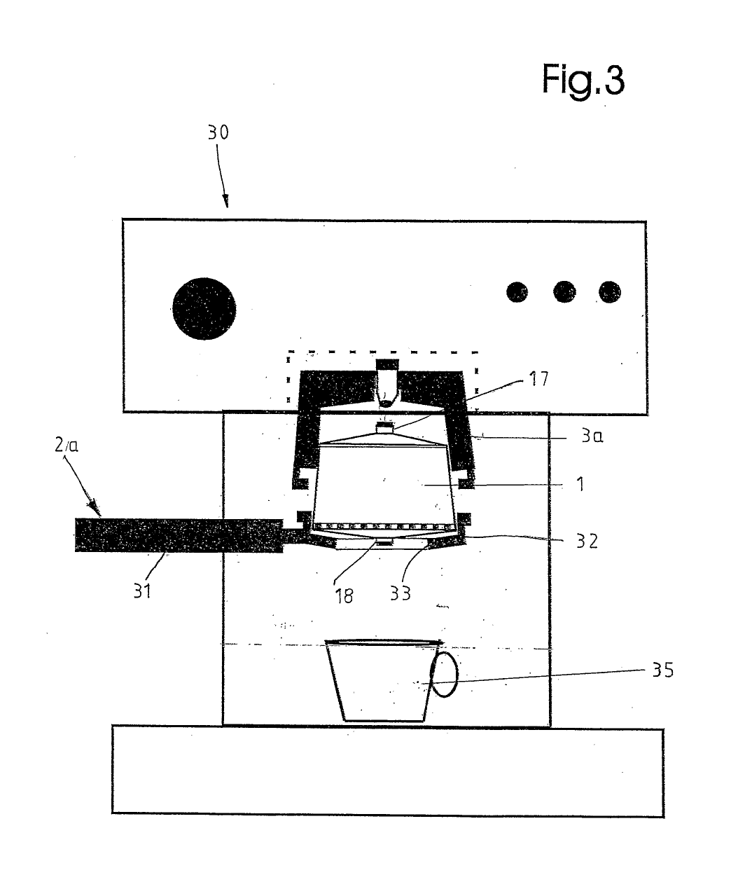

FIG. 3 shows an embodiment of a beverage machine with a capsule holder to be attached to the infusion module;

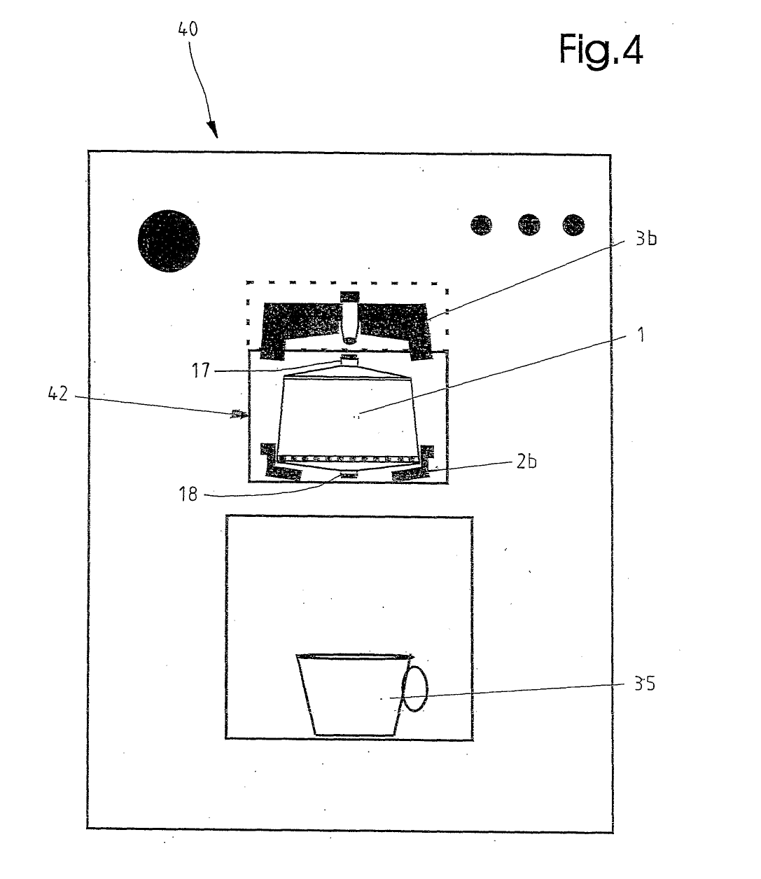

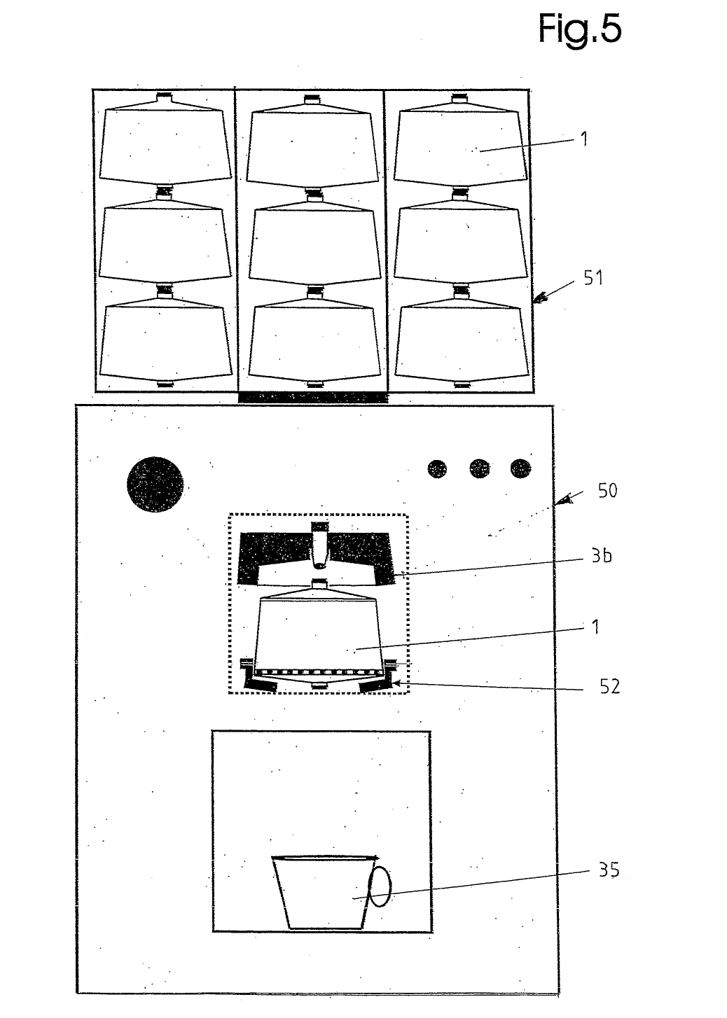

FIG. 4 shows an embodiment of a semi-automatic beverage machine with an infusion module that can be adjusted in relation to a capsule holder; and

FIG. 5 shows an embodiment of a fully automatic beverage machine with an integrated capsule holder module and an infusion module.

FIG. 1 shows a disposable capsule 1 inserted into a capsule holder 2, the same containing a portion of powder or granulate, with which a liquid product, in particular a beverage such as coffee, tea, hot chocolate, soup etc. is to be produced by means of extraction or dissolving with a liquid supplied under pressure (normally hot water). An infusion module 3 is provided above the capsule holder for introducing the pressurised liquid into the disposable capsule 1. The way the liquid is introduced into the disposable capsule 1 and the way the finished product leaves the disposable capsule 1 is described in more detail below.

According to FIG. 2 the disposable capsule 1 of the invention comprises a form-stable housing 11 with an upper facing wall 12, a lower facing wall 13, and a cylindrical, e.g. slightly conical part 14 widening in a downward direction connecting the two facing walls 12, 13. The two facing walls 12, 13 are of a frustoconical shape. A central inlet channel 17 equipped with an inlet closure 16 is allocated to the upper facing wall 12, from where the same conically widens in a downward direction. A central outlet channel 18 equipped with an outlet closure 19 is allocated to the lower facing wall 13 with which the disposable capsule 1 is inserted into the capsule holder 2 (FIG. 1), whereby the lower facing wall 13 is conically tapered in a downward direction towards the outlet channel 18.

The cylindrical, or slightly conical part 14 tapered in a downward direction, of the housing 11 shown in FIG. 2 encloses a hollow space 10 for the powder or granulate, which is separated from an upper inlet chamber 21 enclosed by the upper inlet side facing wall 12 by means of a filter 20. The upper facing wall 12 is preferably equipped with several radial support ribs 22 for the filter 20 distributed across the circumference. In a downward direction the hollow space 10 for the powder or granulate is separated from an outlet chamber 25 conically tapered in the direction of the outlet channel 18 by means of a sieve 24 (and possibly a further filter) enclosed by the lower facing wall 13.

The unused disposable capsule 1 is in an air-tight closed condition. For producing the liquid product, normally a beverage (which could however also be a soup or for example a liquid medicine or suchlike), the inlet channel 17 is connected with the infusion module 3. The inlet closure 16 as well as the outlet closure 19 are formed in such a way that they can be opened to the pressurised liquid supplied from the infusion module 3 by means of hydraulic force alone. The pressure required for this is specifically defined for the different products and is decisive for the product quality.

The liquid introduced via the opened inlet channel 17 is distributed via the inlet side upper facing wall 12 across the entire capsule surface, whereby maximum use is made of the capsule contents. The filter 20 integrated into the disposable capsule 1 filters the incoming liquid and simultaneously prevents a possible backflow of product, e.g. the capsule contents. The finished product flows through the sieve 24 acting as a filter and is collected in the outlet chamber 25 to finally be dispensed via the outlet channel 18 opened purely by means of hydraulic force, which opens when a certain pressure has built up inside the capsule.

Although the frustoconical design of the two facing walls 12, 13 is not absolutely essential it is of great advantage for optimum use of the capsule contents and optimised removal of the finished product from the capsule.

When the disposable capsule 1 of the invention is used the device for producing liquid products by extraction dissolving the powder or granulate contained in the disposable capsule with a pressurised liquid can be of a particularly simple design, as no inlet and/or outlet side mechanical means are required for perforating the disposable capsule 1. According to the invention it is therefore ensured that the liquid product does not come into contact with any part of the infusion module either on the inlet side or with the capsule holder on the outlet side, which could bring with it a flavour or hygiene deterioration when different products are produced with the same means.

With the embodiment of a beverage machine 30 shown in FIG. 3 the disposable capsule 1 of the invention with the desired content is inserted into a capsule holder 2a equipped with a handle 31, namely into a frame 32 of the same, the opening 33 of which has a substantially larger diameter than the outlet channel 18 of the disposable capsule 1. The capsule holder 2a is attached to the fixed infusion module 3a from below, and the closed inlet channel 17 is positioned opposite the infusion module 3a. Following activation of the beverage machine 30 the liquid product is produced in the way described above, and then flows through the opened outlet channel 18 of the disposable capsule 1 into a cup 35. The capsule holder 2a is then disconnected from the infusion module 3a, and the used capsule is removed.

FIG. 4 shows an embodiment of a semi-automatic beverage machine 40 with a capsule holder module 42 comprising a capsule holder 2b integrated into the machine. The disposable capsule 1 is manually inserted into the capsule holder 2b, which can for example also be realised by means of a insertion tray associated with the capsule holder module 42, from the front of the beverage machine 40. The infusion module 3b of the beverage machine 40 is adjustable in relation to the capsule holder module 42, preferably vertically adjustable. When the beverage machine 40 is activated, the infusion module 3b is moved to the inlet channel 17 of the disposable capsule 1 (a tilting movement of the infusion module 3b would also be possible instead of a vertical adjustment), whereafter the product production occurs in the way already described and the liquid product is dispensed through the opened outlet channel 18 of the disposable capsule 1 into a cup 35. The used disposal capsule 1 then drops into a waste container integrated into the beverage machine 40, either automatically or following manual activation, which is however not illustrated in the drawing.

In FIG. 5 an embodiment of a fully automatic beverage machine 50 with an integrated disposable capsule container 51 is schematically illustrated. The beverage machine 50 in turn is equipped with a capsule holder, e.g. capsule holder module 52 and an infusion module 3b that can be adjusted in relation to the same. Following electronic or manual selection of a beverage the beverage machine 50 is activated, whereafter a corresponding disposable capsule 1 is automatically transported from the disposal capsule container 51 to the capsule holder module 52 and the infusion module 3b is moved to the capsule holder module 52 until a direct connection with the disposable capsule 1 is created. Once again the product is produced in the way already described above, and the finished product flows into the cup 35. Finally the used disposable capsule 1 is automatically dropped into a waste container envisaged for this purpose that is integrated into the beverage machine 50.

As already mentioned practically any beverage can be produced one after the other with a high quality flavour as well as excellent hygiene with all of these beverage machines 30, 40, 50 of the invention illustrated as examples in FIGS. 3 to 5 without having to specially clean the individual parts of the machine (infusion module, capsule holder) when the product is changed. Beverage machines of this type are therefore especially user and maintenance friendly.

The disposable capsules of the invention are preferably made from an environmentally friendly material, for example polypropylene.

1. Device for producing liquid products, in particular beverages, by means of extraction or dissolving a powder or granulate in a disposable capsule (1) by supplying a liquid under pressure, with an infusion module (3, 3a, 3b) for introducing the liquid into the disposal capsule (1) inserted into a capsule holder (2, 2a, 2b), with means for emptying the finished product from the disposable capsule (1) and with an outlet channel (18) for the product, characterized in that the disposable capsule (1) comprises a form-stable housing (11) with a hollow space (10) for the powder or granulate and an inlet-side as well as an outlet-side facing wall (12, 13), whereby the inlet-side facing wall (12) is associated with an inlet closure (16), which is connected with the infusion module (3, 3a, 3b), and the outlet-side facing wall (13) is associated with an outlet closure (19) for the finished product, whereby the inlet - as well as the outlet closure (16, 19) can be opened by means of hydraulic force applied by the liquid supplied from the infusion module (3, 3a, 3b) under a defined pressure.

2. Device according to claim 1, characterised in that the capsule holder (2a) with the inlaid disposable capsule (1) is insertable into the infusion module (3a) and therewith the inlet closure (16) with a following inlet channel (17) of the disposable capsule is connectable to the infusion module (3a).

3. Device according to claim 1, characterised in that the capsule holder (2b) forms a part of a capsule holder module (42, 52), in relation to which the infusion module (3b) can be adjusted and connected to the inlet channel (17) of the disposable capsule (1) inserted into the capsule holder (2b).

4. Device according to claim 3, characterised in that the disposable capsule (1) can be inserted into the capsule holder (2b) via an insertion tray of a capsule holder module (42).

5. Device according to claim 3, characterised in that the disposable capsule (1) can be transported from the disposable capsule container (51) to the capsule holder module (52) automatically.

6. Disposable capsule for a device for producing liquid products, in particular beverages, by means of extraction or dissolving a powder or granulate, characterised in that the disposable capsule (1) comprises a form-stable housing (11) with a part (14), which is enclosing a hollow space (10) for the powder or granulate and an inlet-side as well as an outlet-side facing wall (12), whereby the inlet-side facing wall (12) is associated with an inlet closure (16) for the feeding of the liquid under pressure and the outlet-side facing wall (13) is associated with an outlet closure (16) for the finished product, whereby the inlet—as well as the outlet closure (16, 19) can be opened by means of hydraulic force applied by the liquid supplied under pressure.

7. Disposable capsule according to claim 6, characterised in that an inlet and an outlet channel (17, 18) are centrally located near the inlet i.e. the outlet closure in the relevant facing wall (12, 13).

8. Disposable capsule according to claim 7, characterised in that the inlet-side facing wall (12) is of a frustoconical shape and is enclosing an inlet chamber (21), which is in downward direction conically enlarged and is separated from the hollow space (10) for the powder or granulate by a filter (20).

9. Disposable capsule according to claim 7, characterised in that the outlet-side facing wall (13) is of a frustoconical shape and enclosing an outlet chamber (25) conically tapered in a downward direction towards the outlet channel (18) and separated from the hollow space (10) for the powder or granulate by a sieve (24).

10. Disposable capsule according to claim 6, characterised in that the part (14) of the housing (11) connecting the two facing walls (12, 13) and enclosing the hollow space (10) for the powder or granulate is cylindrical, or in that the same widens slightly in a conical shape in outlet direction.
